(19) United States
(12) Patent Application Publication
(10) Pub. No.: US 2009/0321476 A1
(43) Pub. Date: Dec. 31, 2009

(54) BOTTLED WATER COOLERS HAVING A LEAKAGE-PROOF BOTTLE RECEPTACLE WITH A MOVING BAFFLE

(76) Inventor: George M. Yui, Toronto (CA)

Correspondence Address: HPF, P.O. BOX 4442, CHESTERFIELD, MO, 63006-4442, US

(21) Appl. No.: 12/416,467

(22) Filed: Apr. 1, 2009

(30) Foreign Application Priority Data
Jun. 26, 2008 (CN) 2008-20120492

(51) Int. Cl. B67D 5/08

(52) U.S. Cl. 222/67; 222/68; 222/69

(57) ABSTRACT

Bottled water dispensers are disclosed that include a water bottle receptacle. The water bottle receptacle includes a first and second floating baffle (with a hole disposed in the center portion of the second floating baffle). A raised ring having a triangular cross-sectional shape is located at the bottom portion of the receptacle, which makes contact with the second floating baffle, when the second floating baffle is buoyantly forced upwards into the raised ring to close an aperture through which water is transferred from the water bottle into a cold tank of the water dispenser (during hot water sterilization procedures, when the water level in a cold tank of the dispenser exceeds a threshold level). The second floating baffle is effective to prevent the undesirable heating of water contained within the water bottle during such hot water sterilization procedures.

### CROSS-REFERENCE TO RELATED APPLICATIONS

This application claims priority to, and incorporates by reference, Chinese Patent Application Number 2008-20120492, filed Jun. 26, 2008, under 35 U.S.C. § 119.

### FIELD OF THE INVENTION

The present invention relates generally to the field of bottled water dispensers and, more particularly, to bottled water coolers having a leakage-proof bottle receptacle with a moving baffle.

### BACKGROUND OF THE INVENTION

The demand for clean and healthy drinking water is increasing dramatically, which is being driven by the rapid growth in population and standards of living across the globe. This demand has translated into a continuing need for safe, clean, and easy to use water dispensers, including for both hot and cold water.

Many of the currently-available water dispensers suffer from at least several drawbacks. More particularly, many of such water dispensers fail to employ adequate means and structures to prevent the undesirable heating of the water that is contained in the water bottle, during a hot water sterilization process. More particularly, many bottled water dispensers include both a cold water reservoir (i.e., a “cold water tank” or “cold tank”) and a hot water reservoir. It is common to periodically sterilize and clean such cold water reservoirs, which will become infected with bacteria and/or other microorganisms over time, by transferring hot water into the cold water reservoir for a period of time (to kill any such bacteria and/or other microorganisms that may be present therein). In many cases, the sterilizing hot water is transferred from the hot water reservoir into the cold water reservoir to carry out such process. In many of the prior art bottled water dispensers, the water contained within the water bottle is subject to the heat emitted by (and may even mix with) the hot water that is shunted into the cold water reservoir during a sterilization process, which results in the undesirable heating of the water contained within the water bottle.

Many of the prior art bottled water dispensers will utilize a moving baffle that is disposed near the bottom portion of the water receptacle, which closes a gate that prevents the above-described heating of the water contained within the water bottle. However, when the water level in the cold tank drops (i.e., when cold water is dispensed from the water dispenser), residual negative pressure within the cold tank reservoir will often prohibit water from smoothly running into and adequately back-filling the cold tank (the reservoir from which cold water is dispensed). In many cases, the moving baffle will “stick” to a portion of the receptacle, which does not allow such negative pressure to be adequately relieved from the water bottle.

As the following will demonstrate, many of the foregoing problems with currently-available water dispensers are addressed by the present invention.

### SUMMARY OF THE INVENTION

According to certain preferred aspects of the invention, bottled water dispensers are provided that include a water bottle receptacle. The water bottle receptacle will preferably include a first and second floating baffle (with a hole disposed in the center portion of the second floating baffle), a probe disposed through an aperture (or one-way valve) located in the neck portion of the water bottle, a first set of seal rings located on an interior side of the receptacle (which receives the neck portion of the water bottle), a second set of seal rings located on the exterior side of the receptacle (which secure the water bottle cap to the receptacle), a third set of seal rings (which connect the probe to the bottom of the receptacle), a one-way valve located above the first floating baffle and opposite a vent hole, and a raised ring having a triangular cross-sectional shape that is located at the bottom portion of the receptacle—which makes contact with the second floating baffle when the water level in the cold tank of the dispenser has exceeded a certain threshold level (such as during a hot water sterilization procedure). When the second floating baffle contacts and is positioned against the raised ring having a triangular cross-sectional shape, the water contained within the water bottle will not be undesirably heated during, for example, a hot water sterilization procedure.

The invention provides that, in certain preferred embodiments, the second floating baffle will comprise a step-like ring which makes contact with the raised ring mentioned above. Preferably, the raised ring and the step-like ring of the second moving baffle will exhibit approximately the same diameter, thereby providing a continuous area for both rings to make contact with each other. According to certain preferred embodiments of the invention, the hole disposed in the center portion of the second floating baffle has a diameter of about 2-5 mm, such as about 4 mm. Still further, the invention provides that an air filtration sponge is preferably attached to an outside portion of the vent hole, such as an activated charcoal sponge.

The above-mentioned and additional features of the present invention are further illustrated in the Detailed Description contained herein.

### BRIEF DESCRIPTION OF THE FIGURES

FIG. 1: A side cross-sectional view of the bottle receptacle described herein.

FIG. 2: Another side cross-sectional view of the bottle receptacle described herein.

FIG. 3: A magnified view of the area labeled with a “C” in FIG. 2.

FIG. 4: A magnified view of the area labeled with a “D” in FIG. 2.

### DETAILED DESCRIPTION OF THE INVENTION

The following will describe in detail several preferred embodiments of the present invention. These embodiments are provided by way of explanation only, and thus, should not unduly restrict the scope of the invention. In fact, those of ordinary skill in the art will appreciate upon reading the present specification and viewing the present drawings that the invention teaches many variations and modifications, and that numerous variations of the invention may be employed, used and made without departing from the scope and spirit of the invention.

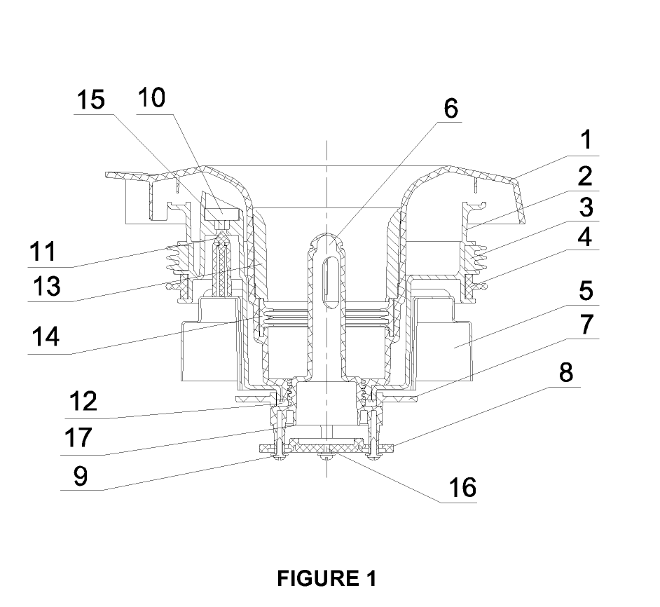

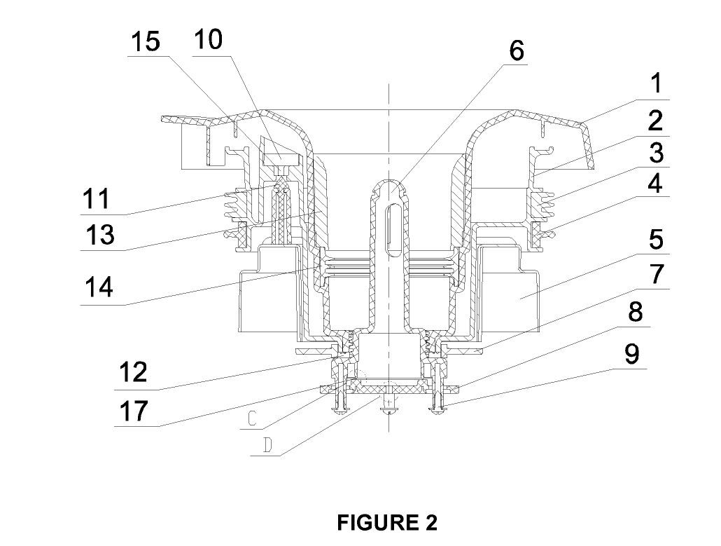

Referring to FIGS. 1-4, according to certain preferred embodiments of the present invention, a bottled water cooler leakage-proof bottle receptacle is shown. The invention provides that the bottle receptacle comprises a middle portion 2 and a top portion 1. The invention further provides that an inverted water bottle (not shown) includes an aperture or, more particularly, a one-way valve located within its neck portion, through which a probe 6 is disposed (with the probe comprising an area through which water may flow from the water bottle, through the bottle receptacle, and into the water dispenser). As shown in FIGS. 1-2, the bottle receptacle further comprises seal rings 13 that surround the interior portion of the receptacle, which receive the neck portion of the water bottle and operate to secure the bottle cap 14 thereto. The invention provides that one or more seal rings 3 and seal rings 4 (such as silicon or thermoplastic rubber (TPR) seal rings) are located on the exterior side of the middle portion 2, which engage the interior surface of the cold tank described herein.

The bottled water dispensers further include a first floating baffle 5 and a second floating baffle 8. Another set of seal rings 12 connect the probe 6 to the bottom of the receptacle. The first floating baffle 5 is preferably hollow, and considerably larger than the second floating baffle 8, with the first floating baffle 5 being positioned above the second floating baffle 8. The invention provides that when the water level within the cold tank exceeds a certain minimum volume, the first floating baffle 5 is buoyantly forced upwards, which causes a one-way valve 11 to also be forced upwards and to close (plug) a vent hole 15 (through which air is allowed to escape from the dispenser when the water level is below such minimum volume). A disc 7 (located below the first floating baffle 5) is held in a stationary position and prevents the first floating baffle 5 from dropping below a certain point (when the water in the cold tank is depleted below such point). In certain preferred embodiments, the receptacle further comprises an air filtration sponge 10, such as an activated charcoal sponge, located outside of the vent hole 15. The filtration sponge 10 will preferably filter and remove contaminants from the air that is vented from the internal parts of the water dispenser. Although FIGS. 1-2 show only a single valve 11 and corresponding vent hole 15, the invention provides that two or more valves 11 and corresponding vent holes 15 may be employed, which may be located around the perimeter of the neck portion of the water bottle—and on opposite ends from each other (relative to the neck portion of the inverted water bottle).

The invention provides that the second floating baffle 8 will exhibit a relative low amount of buoyancy. In certain preferred embodiments, the second floating baffle 8 will be comprised of a material that is slightly less dense than water, such that it exhibits a minimal level of buoyancy. That is, the second floating baffle 8 will preferably be comprised of a material that exhibits a density of between 0.85-0.99 gm/cm³ or, more preferably, between 0.90-0.99 gm/cm³ or, still more preferably, between 0.95-0.99 gm/cm³. For example, in certain preferred embodiments, the second floating baffle 8 will be comprised of polypropylene, which has a density of about 0.95 gm/cm³.

The invention provides that during a hot water sterilization process, extremely hot water (e.g., about 90-degrees Celsius) will be transferred from a hot water tank within the dispenser into the cold water tank within the bottled water dispenser. The hot water will be allowed to incubate in the cold water tank for a period of time, such as for about one hour, to preferably kill any bacteria or other microorganisms that may be present in the cold tank. The bottled water dispenser preferably comprises a microprocessor which may instruct a valve within the dispenser to open, which causes the hot water to be transferred into the cold water tank. Following this sterilization process, the hot water in the cold water tank is preferably cooled by the activation of the cooling system connected thereto. More particularly, the cooling system (e.g., a coolant compressor and condenser) may be periodically activated and deactivated, such as for 15 minute activation and 15 minute deactivation cycles, so as to prevent the cooling system from being overworked and to avoid the overheating of the cooling system (which may otherwise result from the initially high temperature of the hot water contained within the cold tank).

The hot water transferred into the cold tank during the sterilization process may, without the employment of the present invention, undesirably heat the water contained within the water bottle (in view of the close proximity of the neck portion of the water bottle to the hot water). The invention provides that upon the cold tank being provided with a threshold volume of such hot water, the second floating baffle 8 will be buoyantly forced upwards and will close an opening between the neck portion of the water bottle and the internal parts of the dispenser, thereby preventing the water included within the water bottle from becoming heated by the hot water that is shunted into the cold tank during the sterilization process.

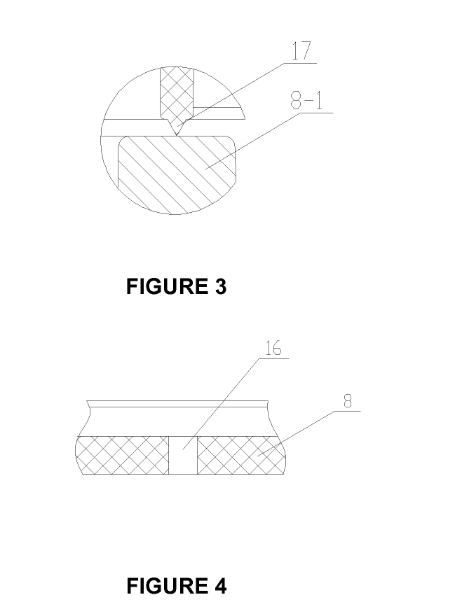

Referring now to FIG. 3, the bottled water cooler leakage-proof bottle receptacle further includes a raised ring 17, which exhibits a triangular cross-sectional configuration and is disposed near the bottom of the receptacle (where certain pads 9 may be located). The invention provides that the second floating baffle 8 will preferably include a corresponding step-like ring 8-1, the diameter of which is the same (or approximately the same) as the diameter of the raised ring 17 describe above, which makes contact with the raised ring 17 (when the second floating baffle 8 is forced upwards to close off the water bottle during the sterilization process, as described above). That is, in certain preferred embodiments of the invention, the second floating baffle 8 will remain adjacent to and in continuous contact with the raised ring 17 (vis-à-vis the corresponding step-like ring 8-1 of the second floating baffle 8), so as to prevent the water contained within the water bottle from being undesirably heated by the hot water located in the proximity thereof (during the sterilization process described herein).

Still further, the invention provides that a hole 16 (FIG. 4) is disposed within the second floating baffle 8, such as in the center portion thereof, whereby the hole may exhibit a diameter of, for example, about 2-5 mm (such as about 4 mm). The invention provides that when the water level in the cold tank drops, at the conclusion of the sterilization process and after water is dispensed from the water dispenser, the hole 16 disposed within the second floating baffle 8 will relieve the negative pressure that would otherwise exist within the water bottle and/or cold tank, thereby allowing water to smoothly run into and back-fill the cold tank. In addition, because a relatively small amount of surface area of the step-like ring 8-1 (of the second floating baffle 8) makes contact with the triangularly-shaped raised ring 17, when the water level within the cold tank drops below the threshold mentioned above, the second floating baffle 8 will not undesirably “stick” to the raised ring 17, thereby facilitating the resumed flow of water from the water bottle into the cold tank.

As explained above, the invention provides that the water dispensers may include reservoirs, and other assemblies, for holding and dispensing hot and cold water. For example, the water dispensers may include an internal cold tank which holds a volume of water, which preferably comprises a means for cooling or chilling the water contained therein, such as by incorporating the use of heat sinks (evaporators) or circulating coolants (refrigerant gasses) along the surfaces thereof. A non-limiting example of such a refrigerant gas includes 134a (tetrafluoroethane). Similarly, the water dispensers may include an internal hot tank, which preferably includes a means for heating the water contained therein, such as by including electric heating coils along or near the surface thereof.

The many aspects and benefits of the invention are apparent from the detailed description, and thus, it is intended for the following claims to cover all such aspects and benefits of the invention which fall within the scope and spirit of the invention. In addition, because numerous modifications and variations will be obvious and readily occur to those skilled in the art, the claims should not be construed to limit the invention to the exact construction and operation illustrated and described herein. Accordingly, all suitable modifications and equivalents should be understood to fall within the scope of the invention as claimed herein.

What is claimed is:

1. A bottled water dispenser which comprises a water bottle receptacle that receives and is connected to a neck portion of an inverted water bottle, wherein the receptacle comprises: (a) a first floating baffle that causes a valve to open or close an air vent hole through which air is allowed to escape an interior portion of the bottled water dispenser; and (b) a second floating baffle located below the first floating baffle with a hole disposed in a center portion thereof, wherein:
(i) the second floating baffle is buoyantly forced into and contacts a raised ring having a triangular cross-sectional shape that is located at a bottom portion of the receptacle upon a water level contained in a cold water tank of the bottled water dispenser exceeding a threshold level; and
(ii) the hole located in the second floating baffle is effective to relieve air pressure from the cold water tank when the water level falls below the threshold level.

2. The bottled water dispenser of claim 1, wherein the water level contained in the cold water tank exceeds the threshold level when hot water is transferred from a hot water tank into the cold water tank during a hot water sterilization process.

3. The bottled water dispenser of claim 2, wherein the second floating baffle comprises a ring which makes contact with the raised ring having a triangular cross-sectional shape.

4. The bottled water dispenser of claim 3, wherein the second floating baffle is comprised of a material that exhibits a density of between about 0.90 gm/cm³ and about 0.99 gm/cm³.

5. The bottled water dispenser of claim 4, wherein the second floating baffle is comprised of polypropylene.

6. The bottled water dispenser of claim 5, wherein the hole disposed in the center portion of the second floating baffle has a diameter between about 2 mm to about 5 mm.

7. The bottled water dispenser of claim 6, wherein the hole disposed in the center portion of the second floating baffle has a diameter of about 4 mm.

8. The bottled water dispenser of claim 7, wherein upon the second floating baffle being forced into and contacting the raised ring, the second floating baffle is effective to prevent water contained within the water bottle from increasing in temperature during the hot water sterilization process.

9. The bottled water dispenser of claim 8, wherein an air filtration sponge is attached to an outside portion of the vent hole.
